(19) United States
(12) Patent Application Publication
(10) Pub. No.: US 2026/0135451 A1
(43) Pub. Date: May 14, 2026

(54) CLAMPING DEVICE FOR STATOR MANUFACTURING SYSTEM

(71) Applicants: Hyundai Motor Company, Seoul (KR); Kia Corporation, Seoul (KR)

(72) Inventors: Jeong Hyeon Kim, Hwaseong (KR); Gwangwon Sung, Hwaseong (KR); Yeongsu Yu, Hwaseong (KR); Hee Chang Choi, Hwaseong (KR); Chang Yeol Kim, Hwaseong (KR); Namhyun Kim, Hwaseong (KR)

(21) Appl. No.: 19/322,187

(22) Filed: Sep. 8, 2025

(30) Foreign Application Priority Data
Nov. 8, 2024 (KR) 10-2024-0158133

(51) Int. Cl. H02K 15/90; H02K 15/026; H02K 15/0643

(52) U.S. Cl. CPC H02K 15/90; H02K 15/026; H02K 15/0643

(57) ABSTRACT

Provided is a clamping device for manufacturing a stator with hairpin-type coils. The device includes a main body, a sub-body that moves vertically, a core inner clamper that grips the stator core's inner diameter, and a coil inner clamper for lower coil portions. A shuttle plate and lifting plate support an upper coil clamp unit above a lower coil clamp unit, both positioning the stator core and coils at multiple angles for processes like coil insertion or welding. At least one sub-actuator moves the lower coil clamp independently from the lifting plate, allowing precise coil engagement. The upper and lower coil clamp units each includes clamp needles with multiple contact surfaces for radial and lateral clamping. By stabilizing the coils during production, the device minimizes positional errors and improves manufacturing efficiency.

### CROSS-REFERENCE TO RELATED APPLICATION

This application claims under 35 U.S.C. § 119 (a) the benefit of Korean Patent Application No. 10-2024-0158133 filed with the Korean Intellectual Property Office on Nov. 8, 2024, the entire contents of which are incorporated herein by reference.

### BACKGROUND

### Technical Field

The present disclosure relates to a clamping device for a stator manufacturing system, particularly for securing both a stator core and hairpin-type coils in multiple directions during manufacturing processes such as coil insertion, twisting, and welding.

### Background

In general, a technology for generating driving power by a drive motor is applied to hybrid vehicles or electric vehicles called environmentally-friendly vehicles.

In order to reduce weights and volumes of vehicles and components, automobile manufacturers and environmentally-friendly component manufacturers are developing drive motors having stators with stator cores around which hairpin-type stator coils are wound (hereinafter, referred to as ‘hairpin-wound-type stators’).

Examples of these hairpin-type stator coils include U-shaped stator coils and I-shaped stator coils.

A hairpin-wound-type stator is typically manufactured by inserting the stator coils into the stator core and then welding the lower ends (hereinafter, referred to as ‘welding portions’) of the stator coils inserted into the stator core.

Meanwhile, before the process of welding the stator coils, processes of processing the stator coils, e.g., a coil widening process of increasing intervals between the welding portions of the stator coils and a coil twisting process of twisting the expanded welding portions are performed.

The coil widening process is required to ensure an insulation distance between the welding portions and improve workability in welding the welding portions. The coil twisting process is required to align electric current flow routes of the welding portions.

During the coil widening process, a coil widening clamper clamps the stator core and the stator coils, and a coil widening tool widens the welding portions of the stator coils.

Further, in the coil twisting process, a coil twisting clamper clamps the stator core and the stator coils, and a coil twisting tool twists the welding portions of the stator coils.

In this case, the stator core is conveyed to the coil twisting process by a conveyor in a state in which the coil widening clamper unclamps the stator core and the stator coils after the stator coils are widened. Then, in the coil twisting process, the coil twisting clamper clamps the stator core and the stator coils again.

However, a positional dispersion of the stator coils may be increased because dedicated clampers are used for the coil widening process and the coil twisting process and the stator core is conveyed from the coil widening process to the coil twisting process by the conveyor.

For this reason, twisting quality of the stator coils may be degraded in the coil twisting process, and welding quality of the stator coils may be degraded in the welding process after the twisting process.

Furthermore, because the dedicated clampers are used for the coil widening process and the coil twisting process, facility investment costs may be increased, and stator productivity may be degraded.

The above information disclosed in this Background section is only to aid understanding of the background of the present disclosure. It may contain subject that does not necessarily reflect known prior art to a person of ordinary skill in the art.

### SUMMARY

The present disclosure attempts to provide a clamping device for a stator manufacturing system, the clamping device being capable of clamping a stator core, into which stator coils are inserted, and transferring the stator core to processing processes.

A clamping device for a stator manufacturing system according to an embodiment of the present disclosure is provided in a stator manufacturing system, which manufactures a stator having a stator core around which hairpin-type stator coils are wound, and the clamping device may include i) a main body connected to a clamper transfer unit, ii) a sub-body installed on the main body and configured to be movable in an upward/downward direction, iii) a core inner clamper installed on the sub-body and configured to clamp an inner diameter surface of the stator core, and iv) a coil inner clamper installed on the core inner clamper and configured to clamp inner sides of lower portions of the stator coils.

In addition, in the clamping device for a stator manufacturing system according to the embodiment of the present disclosure, the core inner clamper may include: a guide housing fixed to the sub-body; a guide tube disposed inside the guide housing so as to penetrate the guide housing in the upward/downward direction and fixed to the sub-body; a collet member disposed inside the guide tube, installed on the sub-body, and configured to be movable in the upward/downward direction; and a plurality of clamp jaws coupled to a cone portion formed on a lower portion of the collet member, configured to be slidable in the upward/downward direction, and mounted to be radially movable by means of a plurality of guide holes formed in a lower portion of the guide tube.

In addition, in the clamping device for a stator manufacturing system according to the embodiment of the present disclosure, the coil inner clamper may include a plurality of clamping blocks respectively fixed to lower portions of the clamp jaws to clamp the inner sides of the lower portions of the stator coils protruding from a lower end of the stator core.

In addition, in the clamping device for a stator manufacturing system according to the embodiment of the present disclosure, the clamp jaws may each include: a core clamping surface configured to clamp an inner diameter surface of the stator core; and a rail protrusion portion slidably coupled to a rail groove formed in the cone portion of the collet member in the upward/downward direction.

In addition, in the clamping device for a stator manufacturing system according to the embodiment of the present disclosure, the clamping blocks may each include: a first portion fixed to the lower portion of each of the clamp jaws; and a second portion extending from the first portion toward the core clamping surface of each of the clamp jaws.

In addition, in the clamping device for a stator manufacturing system according to the embodiment of the present disclosure, the core inner clamper may further include a coil cap member fixed to the guide housing and configured to support an upper portion of the stator coil.

In addition, in the clamping device for a stator manufacturing system according to the embodiment of the present disclosure, the coil cap member may include: a ring-shaped cap body fixed to the guide housing; and a coil guide ring fixed to a lower portion of the cap body and having a coil crown guide portion having a diameter that gradually decreases upward from a lower end thereof to guide the upper portion of each of the stator coils.

In addition, in the clamping device for a stator manufacturing system according to the embodiment of the present disclosure, a plurality of coil support grooves may be formed in an inner peripheral surface of the cap body and configured to support the upper portions of the stator coils.

In addition, in the clamping device for a stator manufacturing system according to the embodiment of the present disclosure, the core inner clamper may further include a plurality of core upper clamping pads mounted on a lower portion of the coil cap member and configured to clamp an upper portion of the stator core.

In addition, the clamping device for a stator manufacturing system according to the embodiment of the present disclosure may further include: v) a shuttle plate coupled to the clamp transfer unit and provided to be movable along a shuttle conveyance route preset on a base frame; vi) a lifting plate installed on the shuttle plate and configured to be movable in the upward/downward direction; vii) an upper coil clamp unit installed on the lifting plate and configured to clamp upper portions of the stator coils; and viii) a lower coil clamp unit disposed below the upper coil clamp unit, connected to the lifting plate, and configured to clamp the lower portions of the stator coils.

In addition, in the clamping device for a stator manufacturing system according to the embodiment of the present disclosure, the upper coil clamp unit may include: an upper support ring disposed below the lifting plate having an upper mounting hole, the upper support ring being fixed to an edge portion of the upper mounting hole; an upper cam disc coupled to a lower portion of the upper support ring and having a plurality of upper guide rail grooves radially formed in an upper surface thereof; an upper swing plate mounted to be rotatable between the upper support ring and the upper cam disc and connected to an upper clamp actuator installed on the lifting plate, the upper swing plate having a plurality of upper cam follower grooves formed in a cyclone shape in a lower surface thereof; a plurality of upper clamp needles radially slidably coupled to the upper guide rail grooves of the upper cam disc; and a plurality of upper cam lobes fixed to the upper clamp needles and slidably coupled to the upper cam follower grooves of the upper swing plate.

In addition, in the clamping device for a stator manufacturing system according to the embodiment of the present disclosure, the upper clamp needles may each include: a first clamping portion configured to clamp an outer side of the upper portion of each of the stator coils in a radially inward direction of the stator core; and a second clamping portion configured to clamp a lateral surface of the upper portion of each of the stator coils in a layer direction of the stator coils.

In addition, in the clamping device for a stator manufacturing system according to the embodiment of the present disclosure, a plurality of pad docking holes may be formed in the upper clamp needles and coupled to a plurality of core upper clamping pads provided on the core inner clamper.

In addition, in the clamping device for a stator manufacturing system according to the embodiment of the present disclosure, the lower coil clamp unit may include: a lower support ring disposed in a lower mounting hole formed in the shuttle plate, mounted on the lifting plate, and configured to be movable in the upward/downward direction; a core support disc coupled to a lower portion of the lower support ring; a lower cam disc coupled to a lower portion of the core support disc and having a plurality of lower guide rail grooves radially formed in an upper surface thereof; a lower swing plate rotatably mounted between the core support disc and the lower cam disc and connected to a lower clamp actuator installed on the lower support ring, the lower swing plate having a plurality of lower cam follower grooves formed in a cyclone shape in a lower surface thereof; a plurality of lower clamp needles radially slidably coupled to the lower guide rail grooves of the lower cam disc; and a plurality of lower cam lobes fixed to the lower clamp needles and slidably coupled to the lower cam follower grooves of the lower swing plate.

In addition, in the clamping device for a stator manufacturing system according to the embodiment of the present disclosure, the lower coil clamp unit may further include: a core support ring coupled to an inner edge portion of the core support disc; and at least one core guide block fixed to the lower support ring.

In addition, in the clamping device for a stator manufacturing system according to the embodiment of the present disclosure, the lower clamp needles may each include: a third clamping portion configured to clamp an outer side of the lower portion of each of the stator coils in a radially inward direction of the stator core; and a fourth clamping portion configured to clamp a lateral surface of the lower portion of each of the stator coils in a layer direction of the stator coils.

In some embodiments, a clamping device for a stator manufacturing system is provided. The clamping device includes: a main body connected to a clamper transfer unit; a sub-body installed on the main body and configured to be movable in an upward/downward direction; a core inner clamper installed on the core inner clamper and configured to clamp inner sides of lower portions of stator coils; a shuttle plate provided to be movable along a shuttle conveyance route preset on a base frame; a lifting plate installed on the shuttle plate and configured to be movable in the upward/downward direction; an upper coil clamp unit installed on the lifting plate and configured to clamp upper portions of the stator coils; a lower coil clamp unit disposed below the upper coil clamp unit and configured to clamp lower portions of the stator coils; and at least one sub-actuator installed on the lifting plate and operatively connected to the lower coil clamp unit, wherein the sub-actuator is configured to move the lower coil clamp unit in an upward/downward direction independently of an upward/downward movement of the lifting plate.

The sub-actuator may include an operation cylinder installed on the lifting plate and connected to the lower coil clamp unit by at least one guide bar that penetrates the lifting plate in the upward/downward direction.

The lower coil clamp unit may include: a lower cam disc having a plurality of lower guide rail grooves radially formed in an upper surface thereof; and a plurality of lower clamp needles radially slidably coupled to the lower guide rail grooves of the lower cm disc, each of the lower camp needs comprising:

The lower coil clamp unit may further include: a lower support ring disposed on the lifting plate and configured to be movable in the upward/downward direction; a core support disc coupled to a lower portion of the stator core.

The clamping device for a stator manufacturing system according to the embodiments of the present disclosure may minimize a positional dispersion between the stator coils, which is caused when the stator core is transferred between the processes and ensure processing quality of the stator coils.

Other effects, which may be obtained or expected by the embodiments of the present disclosure, will be directly or implicitly disclosed in the detailed description on the embodiments of the present disclosure. That is, various effects expected according to the embodiments of the present disclosure will be disclosed in the detailed description to be described below.

As discussed, the method and system suitably include use of a controller or processer. In another embodiment, vehicles are provided that comprise an apparatus as disclosed herein.

### BRIEF DESCRIPTION OF THE DRAWINGS

Because the drawings are provided for reference to describe embodiments of the present disclosure, the technical spirit of the present disclosure should not be construed as being limited to the accompanying drawings.

FIG. 1 is a perspective view illustrating a clamping device for a stator manufacturing system, according to some embodiments of the present disclosure.

FIG. 2 is a front view illustrating the clamping device for a stator manufacturing system according to some embodiments of the present disclosure.

FIG. 3 is a block diagram schematically illustrating manufacturing processes of a stator manufacturing system to which the clamping device for a stator manufacturing system according to some embodiments of the present disclosure is applied.

FIG. 4 is a side view illustrating the clamping device for a stator manufacturing system, according to some embodiments of the present disclosure.

FIG. 5 is an exploded perspective view illustrating a core inner clamper applied to the clamping device for a stator manufacturing system, according to some embodiments of the present disclosure.

FIG. 6 illustrates an example coil cap member (including a ring-shaped cap body and a coil guide ring) for supporting an upper portion of stator coils, according to some embodiments of the present disclosure.

FIG. 7 is a partial cross-sectional view showing coil support grooves formed on an inner peripheral surface of the coil cap member, according to some embodiments of the present disclosure.

FIG. 8 depicts core upper clamping pads mounted on the coil cap member for clamping an upper portion of the stator core, according to some embodiments of the present disclosure.

FIG. 9 is a perspective view illustrating the clamp jaws of the core inner clamper and the clamping blocks of the coil inner clamper, showing how they engage the inner diameter surface of the stator core and clamp the lower portions of the stator coils from the inside, according to some embodiments of the present disclosure.

FIG. 10 is a perspective view illustrating a coil cap member of the core inner clamper applied to the clamping device for a stator manufacturing system, according to some embodiments of the present disclosure.

FIG. 11 is a view illustrating a core upper clamping pad of the core inner clamper applied to the clamping device for a stator manufacturing system, according to some embodiments of the present disclosure.

FIG. 12 is a view for explaining an operation of the coil inner clamper applied to the clamping device for a stator manufacturing system, according to some embodiments of the present disclosure.

FIG. 13 is a front view illustrating another structure of the clamping device for a stator manufacturing system, according to some embodiments of the present disclosure.

FIG. 14 is a perspective view illustrating another structure of the clamping device for a stator manufacturing system, according to some embodiments of the present disclosure.

FIG. 15 is a perspective view illustrating an upper coil clamp unit and a lower coil clamp unit applied to the clamping device for a stator manufacturing system according to some embodiments of the present disclosure.

FIG. 16 is a coupled perspective view illustrating the upper coil clamp unit applied to the clamping device for a stator manufacturing system according to some embodiments of the present disclosure.

FIG. 17 shows a sub-actuator installed on a lifting plate and connected to the lower coil clamp unit, allowing independent vertical movement of the lower clamp, according to some embodiments of the present disclosure.

Claim 18 provides an enlarged or exploded view of lower camp needles arranged radially in the lower coil clamp unit, with structures corresponding to the third/fourth clamping portions, according to some embodiments of the present disclosure.

Claim 19 is a front or perspective view of the assemble clamp device, illustrating how the sub-actuator and clamp needles cooperate to engage the stator coils, according to some embodiments of the present disclosure.

FIG. 20 is a side view illustrating the upper coil clamp unit and the lower coil clamp unit applied to the clamping device for a stator manufacturing system, according to some embodiments of the present disclosure.

FIG. 21 is a coupled perspective view illustrating the lower coil clamp unit applied to the clamping device for a stator manufacturing system, according to some embodiments of the present disclosure.

FIG. 22 is an exploded perspective view illustrating part of the lower coil clamp unit, according to some embodiments of the present disclosure.

FIG. 23 shows the lower coil clamp unit in partial cross section, highlighting the lower coil clamp unit, according to some embodiments of the present disclosure.

FIG. 24 is another exploded or assembled view of the lower coil clamp unit, illustrating how the lower clamp needles clamp the stator coils from multiple directions, according to some embodiments of the present disclosure.

FIG. 25 is a view for explaining an operational effect of the clamping device for a stator manufacturing system, according to some embodiments of the present disclosure.

It should be understood that the accompanying drawings are not necessarily to scale but provide a somewhat simplified representation of various preferred features that exemplify the basic principles of the present disclosure. For example, specific design features of the present disclosure, including particular dimensions, directions, positions, and shapes, will be partially determined by the particularly intended application and use environment.

### DETAILED DESCRIPTION

Hereinafter, embodiments of the present disclosure will be described in detail with reference to the accompanying drawings so that those with ordinary skill in the art to which the present disclosure pertains may easily carry out the embodiments. However, the present disclosure may be implemented in various different ways and is not limited to the embodiments described herein.

A part irrelevant to the description will be omitted to clearly describe the present disclosure, and the same or similar constituent elements will be designated by the same reference numerals throughout the specification.

In addition, the size and thickness of each component illustrated in the drawings are arbitrarily shown for ease of description, but the present disclosure is not limited thereto. In order to clearly describe several portions and regions, thicknesses thereof are enlarged.

The terms used in the present specification are for explaining the exemplary embodiments, not for limiting the present disclosure. The singular expressions used herein are intended to include the plural expressions unless the context clearly dictates otherwise.

It is to be understood that the term “comprise (include)” and/or “comprising (including)” used in the present specification means that the features, the integers, the steps, the operations, the constituent elements, and/or component are present, but the presence or addition of one or more of other features, integers, steps, operations, constituent elements, components, and/or groups thereof is not excluded.

Further, the term ‘coupled’ used in the present specification indicates a physical relationship between two components that are connected directly to each other or connected indirectly through one or more intermediate components.

In addition, in the present specification, the term ‘operably connected’ or another similar term means that at least two members may be connected directly or indirectly to each other and transmit power. However, the two members, which are operably connected to each other, do not always rotate at the same speed and in the same direction.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Furthermore, the terms ‘vehicle,’ ‘for a vehicle,’ and ‘automobile’ or the similar terms used in the present specification generally include vehicles (passenger automobiles) including passenger vehicles, sport utility vehicles (SUVs), buses, trucks, and various commercially available vehicles. The vehicles may include hybrid vehicles, electric vehicles, hybrid electric vehicles, electric vehicle-based purpose-built vehicles (PBVs), and hydrogen power vehicles (typically, also referred to as ‘hydrogen electric vehicles’ by those skilled in the art) mounted with high-voltage batteries.

The term “hairpin-type stator coil” herein refers to a stator coil having a U-shaped or I-shaped geometry, in which two straight or curved leg portions are joined at one end to form a loop that is inserted into the stator core.

The term ‘sub-actuator” herein refers to an additional actuator, such as an operation cylinder or servo motor, that drives a particular clamp assembly independently from the main or primary actuator.

Hereinafter, embodiments of the present disclosure will be described in detail with reference to the accompanying drawings.

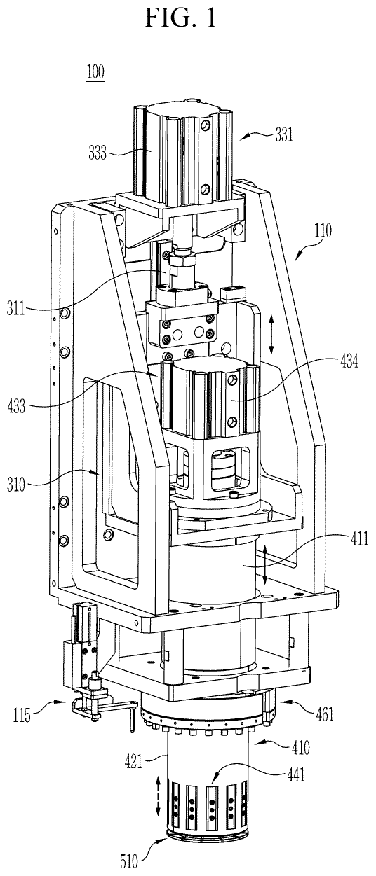

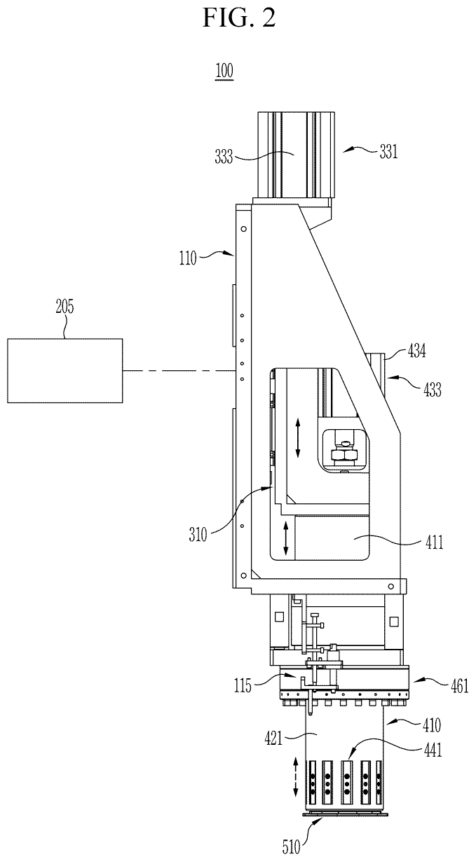

FIG. 1 is a perspective view illustrating a clamping device for a stator manufacturing system according to an embodiment of the present disclosure, and FIG. 2 is a front view illustrating the clamping device for a stator manufacturing system according to the embodiment of the present disclosure.

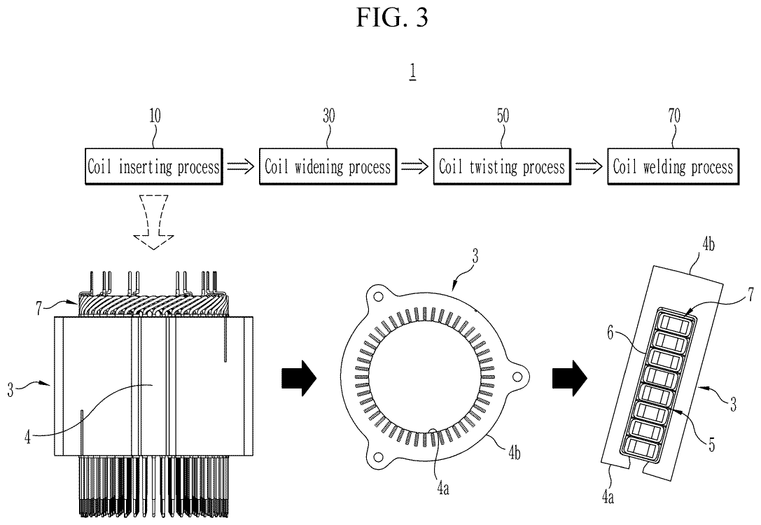

With reference to FIGS. 1 and 2, a clamping device 100 for a stator manufacturing system according to an embodiment of the present disclosure may be applied to a stator manufacturing system 1 (see FIG. 3) that manufactures a hairpin-wound-type stator.

The hairpin-wound-type stator may be applied to a drive motor for an environmentally-friendly vehicle, e.g., a hybrid vehicle and/or an electric vehicle that obtains driving power from electrical energy.

As illustrated in FIG. 3, the stator manufacturing system 1 includes a coil inserting process 10, a coil widening process 30, a coil twisting process 50, and a coil welding process 70.

The coil inserting process 10 performs a process of inserting hairpin-type stator coils 7 into a stator core 3.

The stator core 3 includes an inner diameter surface 4a (or an inner peripheral surface) and an outer diameter surface 4b (or an outer peripheral surface). The stator core 3 includes a plurality of slots 5 (e.g., 48 slots) spaced apart from one another in a circumferential direction. Further, the stator core 3 may be manufactured to have different heights (e.g., a reference height of 100 mm or 150 mm) in accordance with the specifications of the stator. Furthermore, the stator core 3 may be manufactured to have a tolerance height TH (e.g., 0<TH=0.6 mm) larger than the reference height.

The hairpin-type stator coils 7 are inserted into the slots 5 as preset layers (e.g., 8 layers). In this case, the hairpin-type stator coils 7 may be referred to as conductor coils, segment coils, or straight-angle coils.

As an example, the stator coils 7 may include U-shaped stator coils formed as U-shaped hairpin-type stator coils, and I-shaped stator coils formed as I-shaped hairpin-type stator coils.

In the present specification, upper portions (or upper ends) of the stator coils 7 inserted into the slots 5 of the stator core 3 may be defined as crown portions (or head portions), and lower portions (or lower ends) of the stator coils 7 may be defined as leg portions (or welding portions).

In addition, an insulation sheet 6 is inserted into the slots 5 of the stator core 3 to insulate the stator coils 7. The insulation sheet 6 is folded in a preset shape and tightly attached to inner wall surfaces of the slots 5.

The stator coils 7 may be inserted into the insulation sheet 6 in the state in which the insulation sheet 6 is inserted into the slots 5 of the stator core 3.

Hereinafter, an arrangement direction of the stator coils 7 disposed in the slots 5 of the stator core 3 will be referred to as a layer direction.

Further, a side directed toward the stator coil 7 (e.g., the stator coil of layer 1), which is positioned adjacent to the inner diameter surface 4a of the stator core 3 among the stator coils 7, is referred to as an inner side of the stator coils 7.

In addition, a side directed toward the stator coil 7 (e.g., the stator coil of layer 8), which is positioned adjacent to the outer diameter surface 4b of the stator core 3 among the stator coils 7, is referred to as an outer side of the stator coils 7.

Furthermore, a direction directed toward an inner center from the outer diameter surface 4b of the stator core 3 is referred to as a radially inward direction. Further, a direction directed toward the outer diameter surface 4b from the inner center of the stator core 3 is referred to as a radially outward direction.

Meanwhile, the coil widening process 30 performs a process of expanding lower ends of the stator coils 7, which are inserted into the stator core 3, in the radially outward direction of the stator core 3.

The reason why the coil widening process 30 is performed is to ensure an insulation distance between the lower ends of the stator coils 7 and improve the welding workability of the lower ends.

The coil twisting process 50 performs a process of twisting the lower ends of the stator coils 7 after the coil widening process 30.

The reason why the coil twisting process 50 is performed is to align electric current flow routes of the lower ends of the stator coils 7.

Further, the coil welding process 70 performs a process of welding the lower ends of the stator coils 7 twisted in the coil twisting process 50.

In the present specification, reference directions for explaining the following components may be set as a forward/rearward direction, a leftward/rightward direction, and an upward/downward direction based on the drawings.

In the present specification, the terms ‘upper end portion,’ ‘upper portion’, ‘upper end’ or ‘upper surface’ of a component means an end portion, a portion, an end, or a surface of the component which is disposed at a relative upper side, and the terms ‘lower end portion,’ ‘lower portion’, ‘lower end’, or ‘lower surface’ of a component means an end portion, a portion, an end, or a surface of the component which is disposed at a relatively lower side.

Furthermore, in the present specification, an end (e.g., one end or the other end) of a component means an end of the component in any one direction, and an end portion (e.g., one end portion or the other end portion) of a component means a predetermined portion of the component that includes the end of the component.

Meanwhile, the clamping device 100 for a stator manufacturing system according to the embodiment of the present disclosure clamps the stator core 3, into which the stator coils 7 are inserted, and transfers the stator core 3 to the processing processes (e.g., the coil widening process and the coil twisting process).

The clamping device 100 for a stator manufacturing system according to the embodiment of the present disclosure described above provides a structure for minimizing a positional dispersion (or an inadvertent movement) of the stator coils 7 caused when the stator core 3 is transferred between the processes.

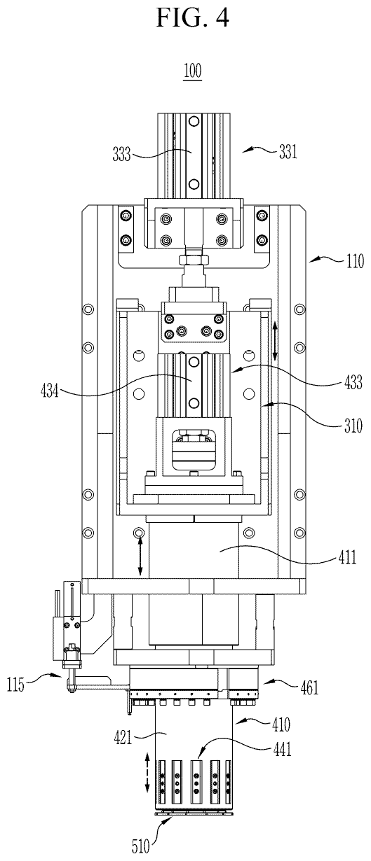

FIG. 4 is a side view illustrating the clamping device for a stator manufacturing system according to the embodiment of the present disclosure.

With reference to FIGS. 1 to 4, the clamping device 100 for a stator manufacturing system according to the embodiment of the present disclosure includes a main body 110, a sub-body 310, a core inner clamper 410, and a coil inner clamper 510.

In the embodiment of the present disclosure, the main body 110 is equipped with various types of constituent elements to be described below. The main body 110 may be configured by one frame or two or more coupled frames.

The main body 110 may include various types of accessory elements, such as a bracket, a plate, a block, a rod, a rib, and a partition wall, configured to support various types of constituent elements.

However, because various types of accessory elements serve to mount the constituent elements, which will be described below, on the main body 110, various types of accessory elements are collectively called the main body 110, except for an exceptional case, in the embodiment of the present disclosure.

The above-mentioned main body 110 may be connected to a clamper transfer unit 205. The clamper transfer unit 205 is configured to transfer the main body 110 to preset positions (e.g., the processing processes for the stator coils).

As an example, the clamper transfer unit 205 may include a handling robot. The handling robot may include an articulated robot known to those skilled in the art and configured to perform the robot operation along a preset teaching route within a working radius. In this case, the main body 110 is installed on an arm of the articulated robot.

As another example, the clamper transfer unit 205 may include a multi-axis robot coupled to the main body 110. The multi-axis robot may include a plurality of rails extending in the forward/rearward direction, the leftward/rightward direction, and the upward/downward direction, and the main body 110 or one rail may move on another rail in a direction in which another rail extends. Because the multi-axis robot, which may move the main body 110 in the forward/rearward direction, the leftward/rightward direction, and the upward/downward direction, is known to those skilled in the art, a further detailed description thereof will be omitted.

In the embodiment of the present disclosure, the sub-body 310 is installed on the main body 110 and configured to be movable in the upward/downward direction.

The sub-body 310 is slidably coupled to a body guide rail 311 fixed to the main body 110 in the upward/downward direction.

The sub-body 310 may reciprocate in the upward/downward direction by an operation of a body driving part 331 by means of the body guide rail 311.

The body driving part 331 is operatively connected to the sub-body 310. The body driving part 331 includes an operation cylinder 333.

The operation cylinder 333 is installed on an upper portion of the main body 110 and connected to the sub-body 310. As an example, the operation cylinder 333 may include a pneumatic cylinder.

Therefore, when the operation cylinder 333 of the body driving part 331 operates forward and rearward, the sub-body 310 may reciprocate in the upward/downward direction.

In the embodiment of the present disclosure, the core inner clamper 410 is configured to clamp the inner diameter surface 4a of the stator core 3.

The core inner clamper 410 may be installed on the sub-body 310 and inserted into the inner side of the stator core 3 in the upward/downward direction.

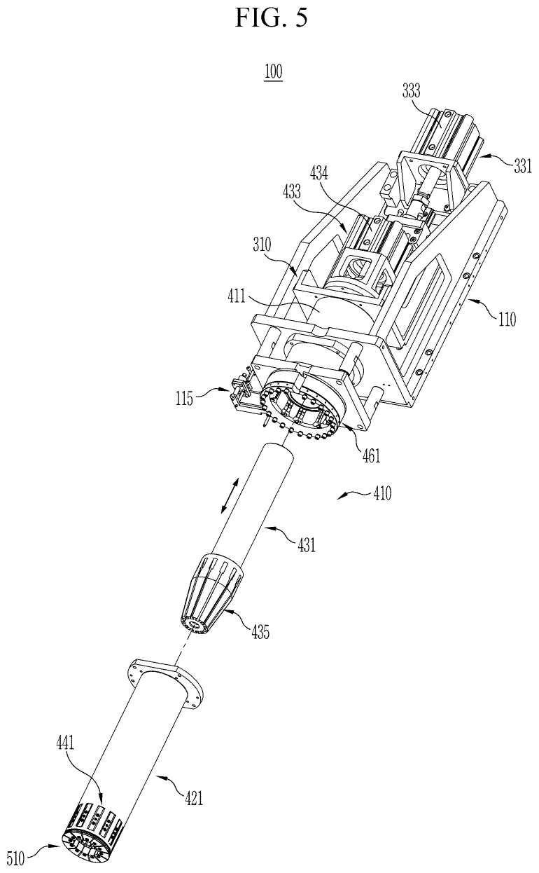

FIG. 5 is an exploded perspective view illustrating the core inner clamper applied to the clamping device for a stator manufacturing system according to the embodiment of the present disclosure.

With reference to FIGS. 1 to 5, the core inner clamper 410 according to the embodiment of the present disclosure includes a guide housing 411, a guide tube 421, a collet member 431, and a plurality of clamp jaws 441.

The guide housing 411 is provided in a cylindrical shape and fixed to the sub-body 310 so as to penetrate a lower portion of the main body 110 in the upward/downward direction.

The guide tube 421 is provided in a cylindrical shape opened at upper and lower ends thereof. The guide tube 421 is fixed to the sub-body 310 and disposed inside the guide housing 411 so as to penetrate the guide housing 411 in the upward/downward direction.

The collet member 431 is disposed inside the guide tube 421, installed on the sub-body 310, and configured to be movable in the upward/downward direction.

The collet member 431 is operatively connected to a collet driving part 433 installed on the sub-body 310. The collet driving part 433 includes an operation cylinder 434 connected to the collet member 431. As an example, the operation cylinder 434 may include a pneumatic cylinder.

Therefore, the collet member 431 may reciprocate inside the guide tube 421 in the upward/downward direction by the forward and rearward operations of the operation cylinder 434.

In this case, the collet member 431 includes a cone portion 435 formed on a lower portion thereof. The cone portion 435 may be provided in a tapered shape having a diameter that gradually decreases from an upper end toward a lower end thereof.

The clamp jaws 441 are configured to clamp the inner diameter surface 4a of the stator core 3. The clamp jaws 441 are coupled to the cone portion 435 of the collet member 431 and are configured to be slidable in the upward/downward direction.

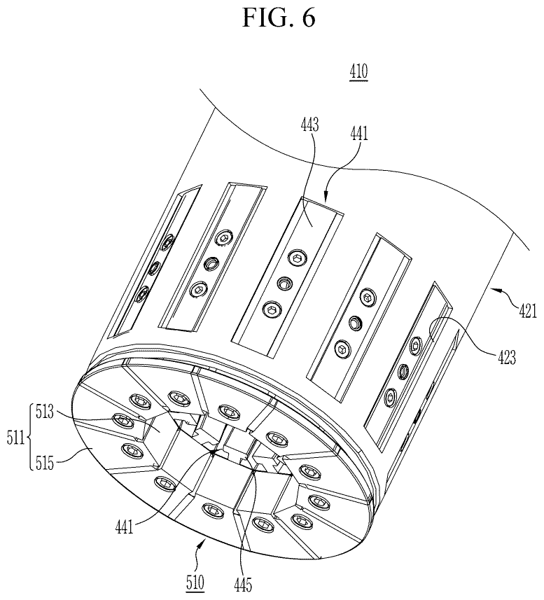

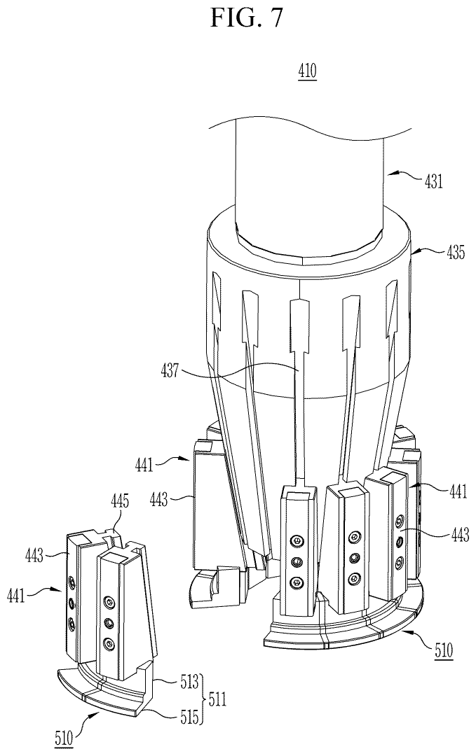

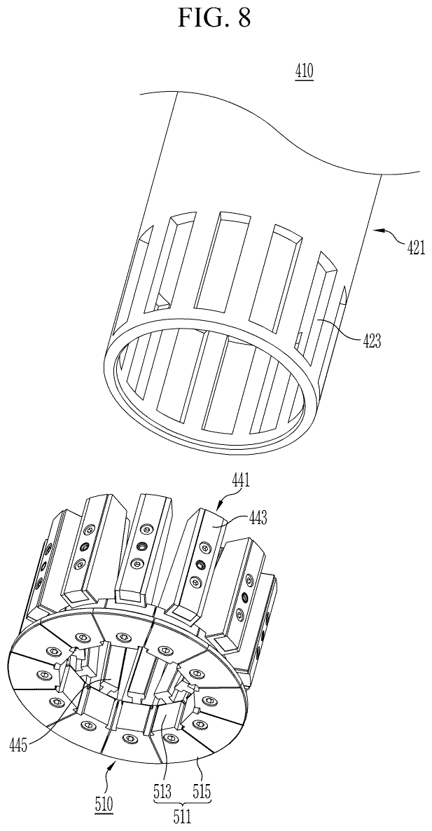

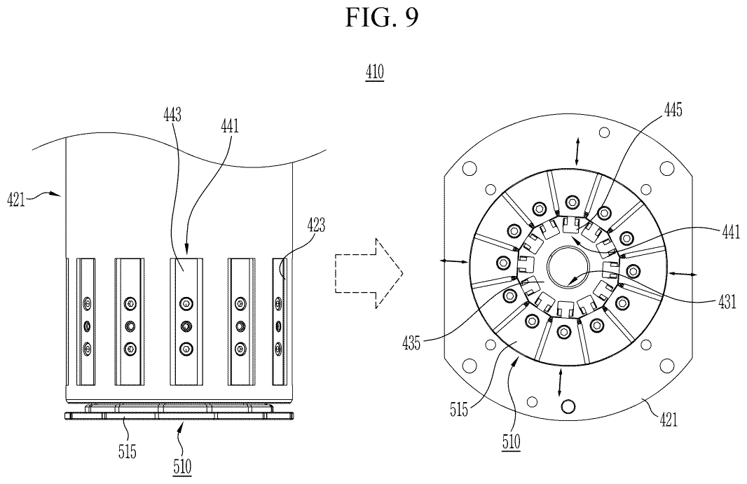

FIGS. 6 to 9 are views illustrating the clamp jaws of the core inner clamper and clamping blocks of the coil inner clamper applied to the clamping device for a stator manufacturing system according to the embodiment of the present disclosure.

With reference to FIGS. 6 to 9, the clamp jaws 441 are provided in a wedge block shape having a width that gradually increases from an upper end toward a lower end thereof.

The clamp jaws 441 each include a core clamping surface 443 and a rail protrusion portion 445.

The core clamping surface 443 may be formed in a round surface that substantially clamps the inner diameter surface 4a (hereinafter, see FIG. 3) of the stator core 3 (hereinafter, see FIG. 3).

The rail protrusion portions 445 are slidably coupled to rail grooves 437 formed in the cone portion 435 of the collet member 431 in the upward/downward direction. As an example, the rail protrusion portion 445 may be formed in a T shape.

The clamp jaws 441 are mounted to be radially movable by means of a plurality of guide holes 423 formed in the lower portion of the guide tube 421 and spaced apart from one another in a circumferential direction.

Therefore, the collet member 431 moves in the downward direction inside the guide tube 421. Then, the clamp jaws 441 slide along the rail grooves 437 of the cone portion 435 by means of the rail protrusion portions 445 and move radially forward by means of the guide holes 423 of the guide tube 421. Therefore, the clamp jaws 441 may clamp the inner diameter surface 4a of the stator core 3 by means of the core clamping surfaces 443.

In addition, the collet member 431 moves in the upward direction inside the guide tube 421. Then, the clamp jaws 441 slide along the rail grooves 437 of the cone portion 435 by means of the rail protrusion portions 445 and move radially rearward by means of the guide holes 423 of the guide tube 421. Therefore, the clamp jaws 441 may unclamp the inner diameter surface 4a of the stator core 3 clamped by the core clamping surfaces 443.

With reference to FIGS. 1 to 5, the core inner clamper 410 according to the embodiment of the present disclosure further includes a coil cap member 461.

The coil cap member 461 is configured to support the upper portions of the stator coils 7 inserted into the stator core 3 (in this case, the upper portion may be defined as a crown portion). That is, the coil cap member 461 may prevent the stator coils 7 from being raised in the upward direction in the stator core 3.

The coil cap member 461 is provided in a ring shape and fixed to the guide housing 411.

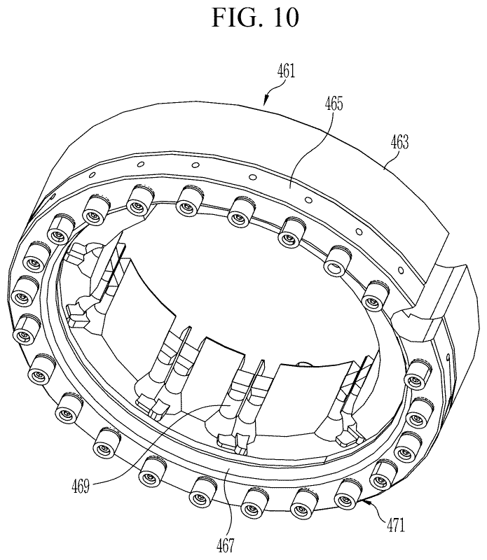

FIG. 10 is a perspective view illustrating the coil cap member of the core inner clamper applied to the clamping device for a stator manufacturing system according to the embodiment of the present disclosure.

With reference to FIG. 10, the coil cap member 461 according to the embodiment of the present disclosure includes a cap body 463 and a coil guide ring 465.

The cap body 463 is provided in a ring shape and fixed to the guide housing 411.

The coil guide ring 465 is configured to guide the upper portions of the stator coils 7 (hereinafter, see FIG. 3). The coil guide ring 465 is fixed to a lower portion of the cap body 463.

In this case, the coil guide ring 465 includes a coil crown guide portion 467 formed on an inner peripheral surface thereof. The coil crown guide portion 467 is formed in a tapered shape having a diameter that gradually decreases from a lower end toward an upper end thereof. The coil crown guide portion 467 may support the upper portions of the stator coils 7 and guide the upper portions of the stator coils 7 toward the inner peripheral surface of the cap body 463.

Furthermore, a plurality of coil support grooves 469 are formed in the inner peripheral surface of the cap body 463 and support the upper portions of the I-shaped stator coils described above among the stator coils 7.

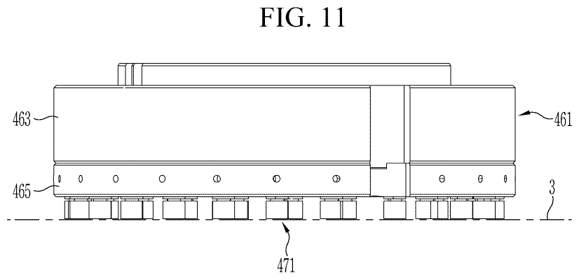

FIG. 11 is a view illustrating a core upper clamping pad of the core inner clamper applied to the clamping device for a stator manufacturing system according to the embodiment of the present disclosure.

With reference to FIGS. 10 and 11, the core inner clamper 410 (see FIG. 1) according to the embodiment of the present disclosure further includes a plurality of core upper clamping pads 471.

In the embodiment of the present disclosure, the core upper clamping pads 471 are configured to clamp the upper portions of the stator cores 3 (hereinafter, see FIG. 3).

The core upper clamping pads 471 are mounted on a lower portion of the coil cap member 461. As an example, the core upper clamping pads 471 are provided as pads made of a plastic material and fixed to the lower portion of the coil guide ring 465.

With reference to FIGS. 1 to 5, in the embodiment of the present disclosure, the coil inner clamper 510 is configured to clamp the inner sides of the lower ends (or lower portions) of the stator coils 7 protruding from the lower end of the stator core 3.

The coil inner clamper 510 is installed at a lower end of the core inner clamper 410.

With reference to FIGS. 6 to 9, the coil inner clamper 510 according to the embodiment of the present disclosure includes a plurality of clamping blocks 511 fixed to the lower portions of the clamp jaws 441 of the core inner clamper 410.

The clamping blocks 511 each include a first portion 513 and a second portion 515.

The first portions 513 are fixed to the lower portions of the clamp jaws 441. The second portions 515 extend from the first portions 513 toward the core clamping surfaces 443 of the clamp jaws 441.

In this case, the second portions 515 are portions that substantially clamp the inner sides of the lower ends of the stator coils 7. The second portions 515 may be disposed at positions deviating from the lower end of the stator core 3.

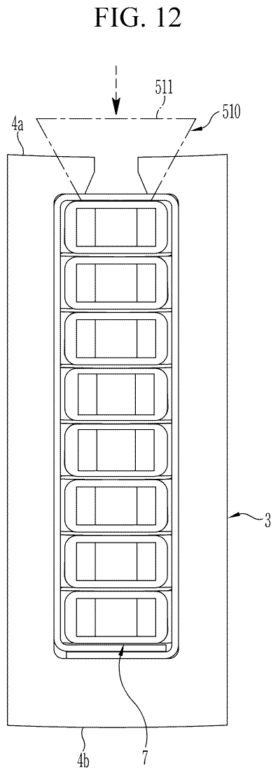

As illustrated in FIG. 12, the clamping blocks 511 of the coil inner clamper 510 may clamp the inner sides of the lower ends of the stator coils 7 in a radially outward direction of the stator core 3 by means of the second portions 515 by the forward movements of the clamp jaws 441.

Reference numeral 115 in the drawings, which has not been described, indicates a core height measurement part. The core height measurement part 115 is installed on the main body 110 and configured to measure the height of the stator core 3. In this case, the height may be defined as an actual height of the stator core 3 made by adding up a preset reference height of the stator core 3 and the tolerance height TH.

Hereinafter, an operation of the clamping device 100 for a stator manufacturing system according to the embodiment of the present disclosure configured as described above will be described in detail with reference to FIGS. 1 to 12.

First, in the embodiment of the present disclosure, the main body 110 is coupled to the clamper transfer unit 205. The sub-body 310 mounted on the main body 110 is in a state of being moved in the upward direction by the operation of the body driving part 331.

The core inner clamper 410 is mounted on the sub-body 310, and the coil inner clamper 510 is mounted on the core inner clamper 410.

Further, the collet member 431 of the core inner clamper 410 is in a state of being moved in the upward direction inside the guide tube 421 by the operation of the collet driving part 433.

As the collet member 431 is moved in the upward direction, the clamp jaws 441 are in a state of being slid along the rail grooves 437 of the cone portion 435 by means of the rail protrusion portions 445 and moved radially rearward by means of the guide holes 423 of the guide tube 421. In this case, the clamp jaws 441 are in a state of being moved rearward together with the clamping blocks 511 of the coil inner clamper 510.

In this state, in the coil inserting process 10, the stator core 3 into which the stator coils 7 are inserted is transferred to a preset position by means of a conveyor.

Next, the main body 110 is transferred to the stator core 3 by the operation of the clamper transfer unit 205. In this case, the core inner clamper 410 and the coil inner clamper 510 are positioned above the stator core 3.

Then, the sub-body 310 is moved in the downward direction by the operation of the body driving part 331 by a stroke corresponding to an actual height of the stator core 3, i.e., an actual height of the stator core 3 measured by the core height measurement part 115.

At the same time, the main body 110 is moved in the downward direction by a stroke corresponding to an actual height of the stator core 3 by the operation of the clamper transfer unit 205. In this case, the main body 110 is moved in the downward direction together with the sub-body 310.

Then, the core inner clamper 410 is inserted into the stator core 3. In this case, the clamp jaws 441 of the core inner clamper 410 are disposed at the positions corresponding to the inner peripheral surface of the stator core 3. Further, the second portions 515 of the clamping blocks 511 of the coil inner clamper 510 are disposed at the positions deviating from the lower end of the stator core 3.

In this process, the coil cap member 461 of the core inner clamper 410 supports the upper portions of the stator coils 7. In this case, the upper portions of the stator coils 7 are guided toward the inner peripheral surface of the cap body 463 by the coil crown guide portion 467 of the coil guide ring 465. In this case, the coil support grooves 469 of the cap body 463 support the upper portions of the I-shaped stator coils among the stator coils 7.

At the same time, the core upper clamping pads 471 of the core inner clamper 410 clamp the upper portions of the stator core 3 by the downward movement of the main body 110.

After the above-mentioned processes, the collet member 431 of the core inner clamper 410 is moved in the downward direction inside the guide tube 421 by the operation of the collet driving part 433.

Then, the clamp jaws 441 slide along the rail grooves 437 of the cone portion 435 of the collet member 431 by means of the rail protrusion portions 445 and move radially forward by means of the guide holes 423 of the guide tube 421. Therefore, the clamp jaws 441 clamp the inner diameter surface 4a of the stator core 3 by means of the core clamping surfaces 443.

In this process, the clamping blocks 511 of the coil inner clamper 510 clamp the inner sides of the lower portions of the stator coils 7 in the radially outward direction of the stator core 3 by means of the second portions 515 by the forward movements of the clamp jaws 441.

Therefore, as described above, the clamping device 100 for a stator manufacturing system according to the embodiment of the present disclosure, the core inner clamper 410 may clamp the stator core 3, and the coil inner clamper 510 may clamp the inner sides of the lower portions of the stator coils 7.

Therefore, the clamping device 100 for a stator manufacturing system according to the embodiment of the present disclosure may transfer the stator core 3 to the processing processes (e.g., the coil widening process and the coil twisting process) for the stator coils 7 in the state in which the stator core 3 and the stator coils 7 are clamped.

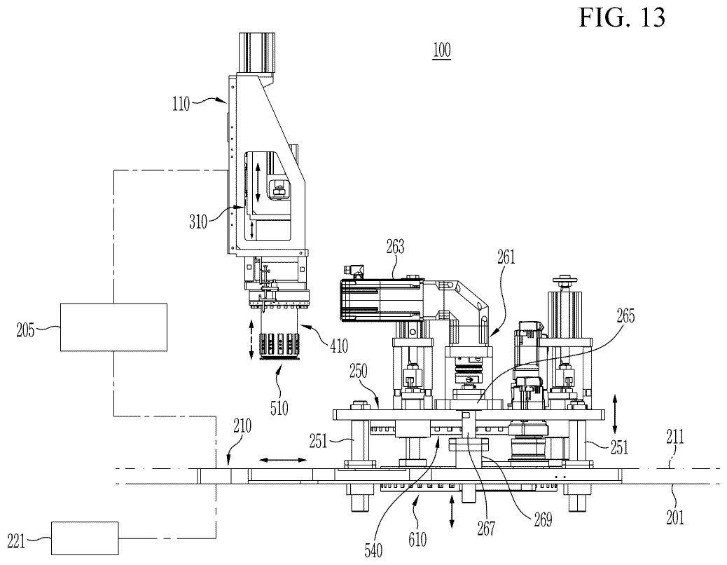

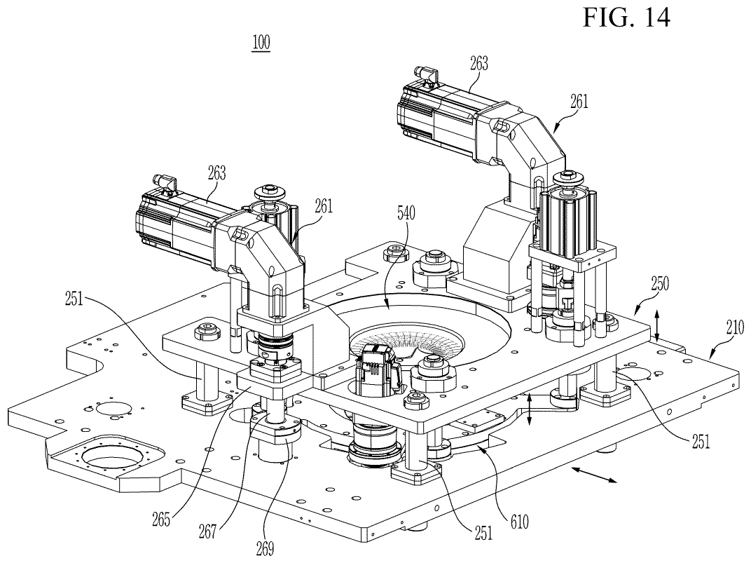

FIG. 13 is a front view illustrating another structure of the clamping device for a stator manufacturing system according to the embodiment of the present disclosure, and FIG. 14 is a perspective view illustrating another structure of the clamping device for a stator manufacturing system according to the embodiment of the present disclosure.

With reference to FIGS. 13 and 14, the clamping device 100 for a stator manufacturing system according to the embodiment of the present disclosure may provide a structure capable of clamping the stator core 3 (hereinafter, see FIG. 3) and the stator coils 7 (hereinafter, see FIG. 3) at several positions.

To this end, the clamping device 100 for a stator manufacturing system according to the embodiment of the present disclosure basically includes the core inner clamper 410 and the coil inner clamper 510 and further includes a shuttle plate 210, a lifting plate 250, an upper coil clamp unit 540, and a lower coil clamp unit 610.

In the embodiment of the present disclosure, the shuttle plate 210 is configured to be movable in the forward/rearward direction and installed on a base frame 201 disposed along the processing processes for the stator coils 7.

The shuttle plate 210 may reciprocate along a shuttle conveyance route 211 (e.g., in the forward/rearward direction) preset on the base frame 201.

In this case, the above-mentioned clamper transfer unit 205 is coupled to the shuttle plate 210.

The shuttle plate 210 may be slidably coupled to a guide rail (not illustrated) fixed to the base frame 201 and reciprocated along the shuttle conveyance route 211 by an operation of a shuttle driving part 221. In this case, the shuttle driving part 221 may include a servo motor, a pinion gear, and a rack bar well known to those skilled in the art.

In the embodiment of the present disclosure, the lifting plate 250 is installed on the shuttle plate 210 and configured to be movable in the upward/downward direction. The lifting plate 250 may move in the upward/downward direction by means of a plurality of guide rods 251.

In this case, the guide rods 251 may be fixed to the lifting plate 250 so as to penetrate the shuttle plate 210 in the upward/downward direction.

At least one main actuator 261 is installed on the lifting plate 250 and connected to the shuttle plate 210. At least one main actuator 261 is operatively connected to the lifting plate 250. At least one main actuator 261 may be disposed at each of two opposite sides of the lifting plate 250 based on the leftward/rightward direction.

At least one main actuator 261 includes a main servo motor 263, a main movement block 265, and a main lead screw 267.

The main servo motor 263 is installed on the lifting plate 250. The main servo motor 263 may be a motor capable of servo-controlling a rotation direction, a rotation speed, and a rotation amount.

The main movement block 265 is fixed to the lifting plate 250 at a position corresponding to the main servo motor 263.

The main lead screw 267 is connected to the main servo motor 263 and disposed in the upward/downward direction. The main lead screw 267 is screw-coupled to the main movement block 265 and rotatably coupled to a main support block 269 fixed to the shuttle plate 210. Therefore, when the main servo motor 263 operates, the main lead screw 267 rotates, such that the lifting plate 250 may reciprocate in the upward/downward direction by means of the main movement block 265.

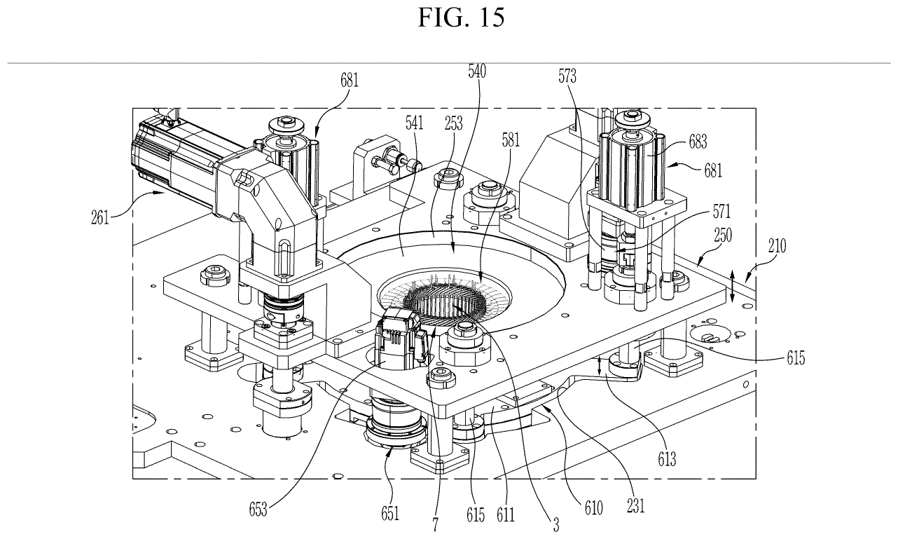

FIG. 15 is a perspective view illustrating the upper coil clamp unit and the lower coil clamp unit applied to the clamping device for a stator manufacturing system according to the embodiment of the present disclosure.

With reference to FIG. 15, in the embodiment of the present disclosure, the upper coil clamp unit 540 is configured to clamp the upper portions of the stator coils 7 inserted into the stator core 3 in a state in which the stator core 3 is placed on the lower coil clamp unit 610 to be described below.

That is, the upper coil clamp unit 540 may prevent the stator coils 7 from being lowered in the downward direction in the stator core 3.

The upper coil clamp unit 540 is installed on the lifting plate 250.

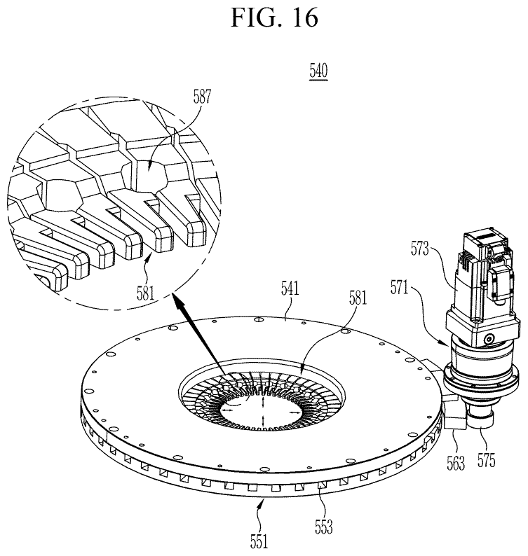

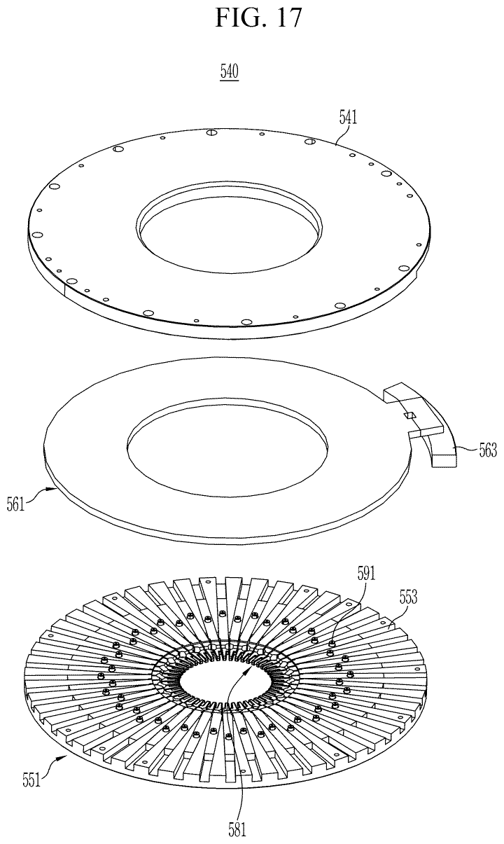

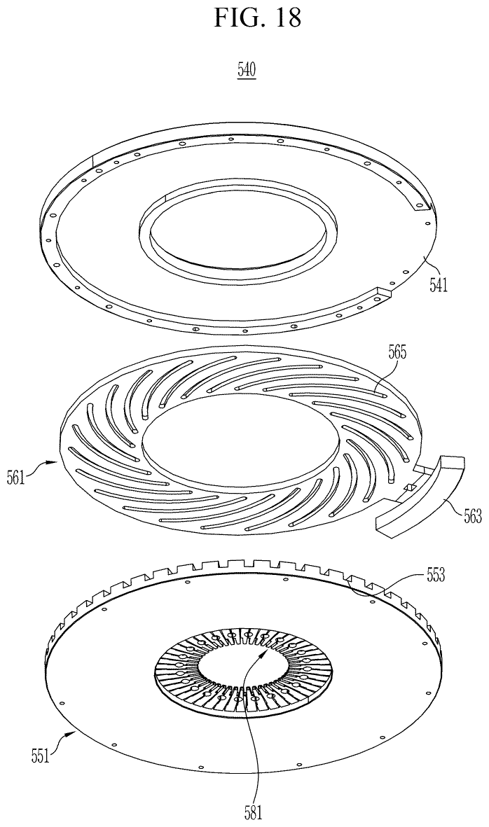

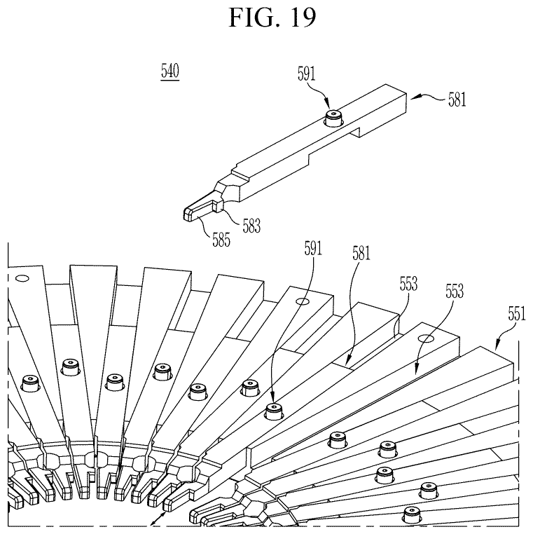

FIG. 16 is a coupled perspective view illustrating the upper coil clamp unit applied to the clamping device for a stator manufacturing system according to the embodiment of the present disclosure, and FIGS. 17 to 19 are exploded perspective views illustrating the upper coil clamp unit applied to the clamping device for a stator manufacturing system according to the embodiment of the present disclosure.

With reference to FIGS. 15 to 19, the upper coil clamp unit 540 according to the embodiment of the present disclosure includes an upper support ring 541, an upper cam disc 551, an upper swing plate 561, a plurality of upper clamp needles 581, and a plurality of upper cam lobes 591.

The upper support ring 541 is provided in a ring or disc shape and disposed below the lifting plate 250 having an upper mounting hole 253. The upper support ring 541 is fixed to an edge portion of the upper mounting hole 253.

The upper cam disc 551 is provided in a disc shape having a disc hole and coupled to a lower portion of the upper support ring 541. The upper cam disc 551 includes a plurality of upper guide rail grooves 553 radially formed on an upper surface thereof.

The upper swing plate 561 is rotatably mounted between the upper support ring 541 and the upper cam disc 551. The upper swing plate 561 is provided in a disc shape.

The upper swing plate 561 includes an upper part gear 563 coupled to an outer edge thereof. The upper part gear 563 is provided as a parting gear having a curvature corresponding to an outer diameter of the upper swing plate 561.

Further, the upper swing plate 561 includes a plurality of upper cam follower grooves 565 formed in a cyclone shape on a lower surface thereof.

The upper clamp needles 581 are configured to substantially clamp the upper portions of the stator coils 7. The upper clamp needles 581 are radially slidably coupled to the upper guide rail grooves 553 of the upper cam disc 551. The upper clamp needles 581 may move radially forward and rearward along the upper guide rail grooves 553.

The upper cam lobes 591 are fixed to the upper clamp needles 581 and respectively and slidably coupled to the upper cam follower grooves 565 of the upper swing plate 561.

Therefore, when the upper swing plate 561 rotates, the upper clamp needles 581 may be moved radially forward and rearward along the upper guide rail grooves 553 of the upper cam disc 551 by cam-operations of the upper cam lobes 591 and the upper cam follower grooves 565.

In this case, the upper clamp needles 581 each include a first clamping portion 583 and a second clamping portion 585.

The first clamping portions 583 are configured to clamp the outer sides of the upper portions of the stator coils 7 in the radially inward direction of the stator core 3. Further, the second clamping portions 585 are configured to clamp lateral surfaces of the upper portions of the stator coils 7 in the layer direction of the stator coils 7.

The second clamping portions 585 extend from bodies of the upper clamp needles 581 in the radially inward direction of the stator core 3. Further, the first clamping portion 583 protrudes from the second clamping portion 585 in a radial direction of the stator core 3.

Furthermore, the upper swing plate 561 is connected to an upper clamp actuator 571 installed on the lifting plate 250. The upper clamp actuator 571 is operatively connected to the upper swing plate 561 by means of the upper part gear 563 coupled to the upper swing plate 561.

The upper clamp actuator 571 includes an upper servo motor 573 and an upper pinion gear 575.

The upper servo motor 573 is fixed to the lifting plate 250. The upper servo motor 573 may be a motor capable of servo-controlling a rotation direction, a rotational speed, and a rotation amount.

The upper pinion gear 575 is connected to the upper servo motor 573 and engages with the upper part gear 563.

Therefore, when the upper servo motor 573 operates, the upper pinion gear 575 rotates, such that the upper swing plate 561 may be rotated forward or reversely by the upper part gear 563 engaging with the upper pinion gear 575.

The upper coil clamp unit 540 configured as described above may be reciprocated in the upward/downward direction together with the lifting plate 250 by the operation of at least one main actuator 261.

Reference numeral 587 in FIG. 16, which has not been described, indicates pad docking holes formed in the upper clamp needles 581. The pad docking holes 587 may be formed in the adjacent bodies of the upper clamp needles 581.

The pad docking holes 587 may be formed by merging grooves formed in semicircular shapes in the bodies of the adjacent upper clamp needles 581. The core upper clamping pads 471 illustrated in FIGS. 10 and 11 may be coupled to the pad docking holes 587.

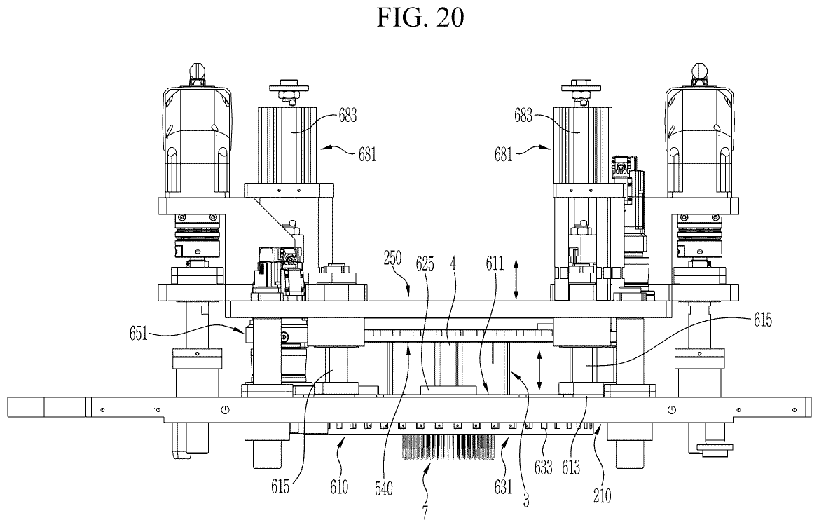

FIG. 20 is a side view illustrating the upper coil clamp unit and the lower coil clamp unit applied to the clamping device for a stator manufacturing system according to the embodiment of the present disclosure.

With reference to FIGS. 15 and 20, in the embodiment of the present disclosure, the lower coil clamp unit 610 is configured to support the stator core 3 and clamp the lower portions of the stator coils 7 inserted into the stator core 3.

That is, the lower coil clamp unit 610 may prevent the stator coils 7 from being lowered in the downward direction in the stator core 3.

The lower coil clamp unit 610 is disposed below the lifting plate 250 and the upper coil clamp unit 540, installed on the lifting plate 250, and configured to be movable in the upward/downward direction.

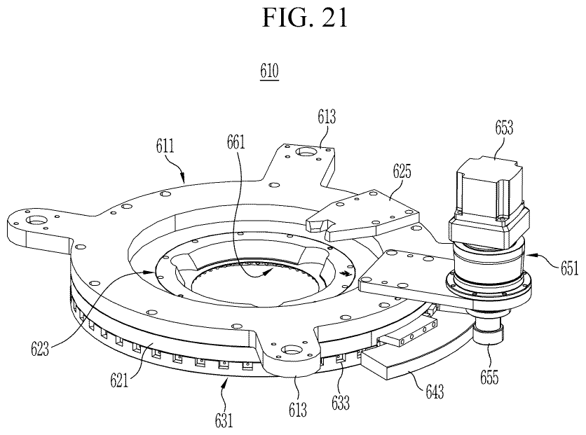

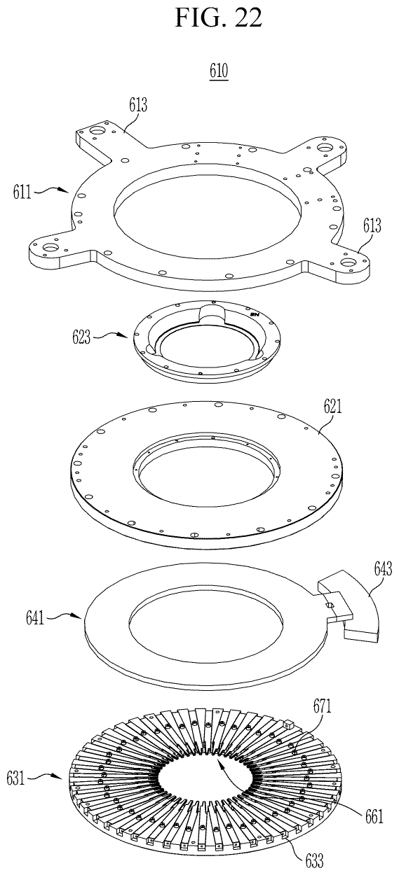

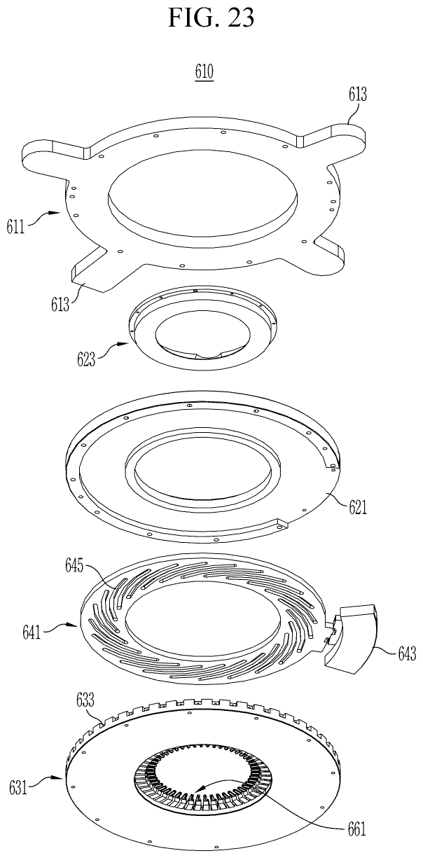

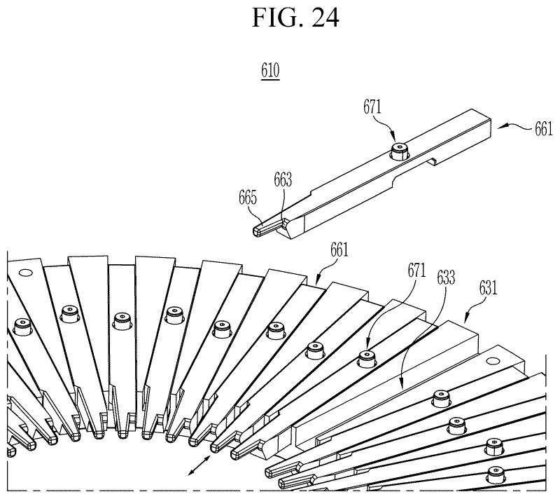

FIG. 21 is a coupled perspective view illustrating the lower coil clamp unit applied to the clamping device for a stator manufacturing system according to the embodiment of the present disclosure, and FIGS. 22 to 24 are exploded perspective views illustrating the lower coil clamp unit applied to the clamping device for a stator manufacturing system according to the embodiment of the present disclosure.

With reference to FIGS. 20 to 24, the lower coil clamp unit 610 according to the embodiment of the present disclosure includes a lower support ring 611, a core support disc 621, a core support ring 623, at least one core guide block 625, a lower cam disc 631, a lower swing plate 641, a plurality of lower clamp needles 661, and a plurality of lower cam lobes 671.

The lower support ring 611 is provided in a ring or disc shape, disposed at a position corresponding to the upper mounting hole 253 (see FIG. 15) of the lifting plate 250 and disposed in a lower mounting hole 231 (see FIG. 15) formed in the shuttle plate 210.

The lower support ring 611 is mounted on the lifting plate 250 and configured to be movable in the upward/downward direction. The lower support ring 611 may be mounted on the lifting plate 250 and configured to be movable in the upward/downward direction by means of a plurality of guide bars 615 (illustrated in FIG. 15).

In this case, the lower support ring 611 includes a plurality of ribs 613 extending outward from an edge portion thereof.

The guide bars 615 are fixed to the ribs 613. The guide bars 615 penetrate the lifting plate 250 in the upward/downward direction and are mounted to be stopped by means of an upper surface of the lifting plate 250.

The core support disc 621 is configured to support the load of the stator core 3. The core support disc 621 is provided in a disc shape having a disc hole and coupled to a lower portion of the lower support ring 611.

The core support ring 623 is configured to support the lower portion of the stator core 3. The core support ring 623 is provided in a ring shape and coupled to an inner edge portion of the core support disc 621.

At least one core guide block 625 is configured to guide at least one protruding portion 4 protruding from an outer peripheral surface of the stator core 3 in the upward/downward direction. At least one core guide block 625 is coupled to an upper surface of the lower support ring 611.

The lower cam disc 631 is provided in a disc shape having a disc hole and coupled to a lower portion of the core support disc 621. The lower cam disc 631 includes a plurality of lower guide rail grooves 633 radially formed in an upper surface thereof.

The lower swing plate 641 is rotatably mounted between the core support disc 621 and the lower cam disc 631. The lower swing plate 641 is provided in a disc shape.

The lower swing plate 641 includes a lower part gear 643 coupled to an outer edge thereof. The lower part gear 643 is provided as a parting gear having a curvature corresponding to an outer diameter of the lower swing plate 641.

Further, the lower swing plate 641 includes a plurality of lower cam follower grooves 645 formed in a cyclone shape in a lower surface thereof.

The lower clamp needles 661 are configured to substantially clamp the lower portions of the stator coils 7. The lower clamp needles 661 are radially slidably coupled to the lower guide rail grooves 633 of the lower cam disc 631. The lower clamp needles 661 may move radially forward and rearward along the lower guide rail grooves 633.

The lower cam lobes 671 are fixed to the lower clamp needles 661 and respectively and slidably coupled to the lower cam follower grooves 645 of the lower swing plate 641.

Therefore, when the lower swing plate 641 rotates, the lower clamp needles 661 may be moved radially forward and rearward along the lower guide rail grooves 633 of the lower cam disc 631 by cam-operations of the lower cam lobes 671 and the lower cam follower grooves 645.

In this case, the lower clamp needles 661 each include a third clamping portion 663 and a fourth clamping portion 665.

The third clamping portions 663 are configured to clamp the outer sides of the lower portions of the stator coils 7 in the radially inward direction of the stator core 3. Further, the fourth clamping portions 665 are configured to clamp lateral surfaces of the lower portions of the stator coils 7 in the layer direction of the stator coils 7.

The fourth clamping portions 665 extend from bodies of the lower clamp needles 661 in the radially inward direction of the stator core 3. Further, the third clamping portions 663 are formed on the bodies of the lower clamp needles 661. The third clamping portions 663 are formed on the bodies of the lower clamp needles 661 and formed at connection ends of the fourth clamping portions 665.

Furthermore, the lower swing plate 641 is connected to a lower clamp actuator 651 (also illustrated in FIG. 15) installed on the lower support ring 611. The lower clamp actuator 651 is operatively connected to the lower swing plate 641 by means of the lower part gear 643 coupled to the lower swing plate 641.

The lower clamp actuator 651 includes a lower servo motor 653 and a lower pinion gear 655.

The lower servo motor 653 is fixed to the lower support ring 611 by means of a bracket. The lower servo motor 653 penetrates the lifting plate 250 in the upward/downward direction. The lower servo motor 653 may be a motor capable of servo-controlling a rotation direction, a rotation speed, and a rotation amount.

The lower pinion gear 655 is connected to the lower servo motor 653 and engages with the lower part gear 643.

Therefore, when the lower servo motor 653 operates, the lower pinion gear 655 rotates, such that the lower swing plate 641 may be rotated forward or reversely by the lower part gear 643 engaging with the lower pinion gear 655.

The lower coil clamp unit 610 configured as described above, together with the upper coil clamp unit 540, may be reciprocated in the upward/downward direction by the lifting plate 250.

Furthermore, the lower coil clamp unit 610 may be reciprocated in the upward/downward direction by the operation of at least one sub-actuator 681 (also illustrated in FIG. 15) independently of the lifting plate 250 and the upper coil clamp unit 540.

At least one sub-actuator 681 is installed on the lifting plate 250 and operatively connected to the lower support ring 611 of the lower coil clamp unit 610.

At least one sub-actuator 681 includes an operation cylinder 683 fixed to the lifting plate 250. As an example, the operation cylinder 683 may include a pneumatic cylinder.

In this case, the operation cylinder 683 is fixed to the ribs 613 of the lower support ring 611 and connected to at least one of the guide bars 615 that penetrate the lifting plate 250.

Therefore, when the operation cylinder 683 operates forward and rearward, the lower coil clamp unit 610 may reciprocate in the upward/downward direction by means of the guide bars 615.

Hereinafter, an operation of another structure of the clamping device 100 for a stator manufacturing system according to the embodiment of the present disclosure configured as described above will be described in detail with reference to FIGS. 1 to 24.

First, in the embodiment of the present disclosure, the lifting plate 250 on the shuttle plate 210 is in a state of being moved in the upward direction together with the upper coil clamp unit 540 and the lower coil clamp unit 610 by the operation of at least one main actuator 261.

In this case, the upper clamp needles 581 of the upper coil clamp unit 540 are in a state of being moved rearward by the operation of the upper clamp actuator 571. Further, the lower clamp needles 661 of the lower coil clamp unit 610 are in a state of being moved rearward by the operation of the lower clamp actuator 651.

Further, the core inner clamper 410 and the coil inner clamper 510 are in a state of being moved on the shuttle plate 210 in a direction away from the upper coil clamp unit 540 and the lower coil clamp unit 610 by the operation of the clamper transfer unit 205.

In the above-mentioned state, the stator core 3, into which the stator coils 7 are inserted in the coil inserting process 10, is provided.

Next, the stator core 3 is loaded onto the lower coil clamp unit 610 by means of the upper coil clamp unit 540 by a robot gripper (not illustrated). In this case, the stator core 3 is loaded onto the core support ring 623 coupled to an inner edge portion of the core support disc 621.

The height (e.g., the reference height) of the stator core 3 may vary depending on the specifications of the stator.

Therefore, the lower coil clamp unit 610 is moved in the upward/downward direction by a preset stroke in accordance with the reference height of the stator core 3 by the operation of at least one sub-actuator 681.

The lower coil clamp unit 610 is moved in the upward/downward direction independently of the lifting plate 250 and the upper coil clamp unit 540.

Therefore, the upper portions of the stator coils 7 inserted into the stator core 3 face the upper clamp needles 581, and the lower portions of the stator coils 7 face the lower clamp needles 661.

Next, the core inner clamper 410 and the coil inner clamper 510 are moved on the shuttle plate 210 toward the upper coil clamp unit 540 and the lower coil clamp unit 610 by the operation of the clamper transfer unit 205.

Then, the core inner clamper 410 and the coil inner clamper 510 are positioned above the upper coil clamp unit 540.

During the above-mentioned processes, the upper clamp needles 581 of the upper coil clamp unit 540 are moved radially forward by the operation of the upper clamp actuator 571.

Therefore, the upper clamp needles 581 clamp the upper portions of the stator coils 7. In this case, the first clamping portions 583 of the upper clamp needles 581 clamp the outer sides of the upper portions of the stator coils 7 in the radially inward direction of the stator core 3. Further, the second clamping portions 585 of the upper clamp needles 581 clamp the lateral surfaces of the upper portions of the stator coils 7 in the layer direction of the stator coils 7.

In this process, with the above-mentioned operation, the core inner clamper 410 supports the upper portions of the stator coils 7, clamps the upper portion of the stator core 3, and clamps the inner diameter surface 4a of the stator core 3.

At the same time, with the above-mentioned operation, the coil inner clamper 510 clamps the inner sides of the lower portions of the stator coils 7 in the radially outward direction of the stator core 3.

Then, the lower clamp needles 661 of the lower coil clamp unit 610 are moved radially forward by the operation of the lower clamp actuator 651.

Therefore, the lower clamp needles 661 clamp the lower portions of the stator coils 7.

The third clamping portions 663 of the lower clamp needles 661 clamp the outer sides of the lower portions of the stator coils 7 in the radially inward direction of the stator core 3. Further, the fourth clamping portions 665 of the lower clamp needles 661 clamp the lateral surfaces of the lower portions of the stator coils 7 in the layer direction of the stator coils 7. Therefore, in the embodiment of the present disclosure, the core upper clamping pads 471 of the core inner clamper 410 may clamp the upper portion of the stator core 3 in the state in which the stator core 3 is supported on the core support ring 623 of the lower coil clamp unit 610.

In this case, the core upper clamping pads 471 may clamp the upper portion of the stator core 3 by means of the pad docking holes 587 formed in the upper clamp needles 581.

In addition, in the embodiment of the present disclosure, the clamp jaws 441 of the core inner clamper 410 may clamp the inner diameter surface 4a of the stator core 3.

Further, in the embodiment of the present disclosure, the coil cap member 461 of the core inner clamper 410 may support the upper portions of the stator coils 7, and the coil inner clamper 510 may clamp the inner sides of the lower portions of the stator coils 7.

Further, in the embodiment of the present disclosure, the upper clamp needles 581 of the upper coil clamp unit 540 may clamp the outer side and the lateral surface of the upper portion of the stator core 3.

Furthermore, in the embodiment of the present disclosure, the lower clamp needles 661 of the lower coil clamp unit 610 may clamp the outer sides and the lateral surfaces of the lower portions of the stator coils 7.

Therefore, the core inner clamper 410, the upper coil clamp unit 540, and the lower coil clamp unit 610 may clamp the stator core 3 at several positions (e.g., in the upward, downward, and inward directions).

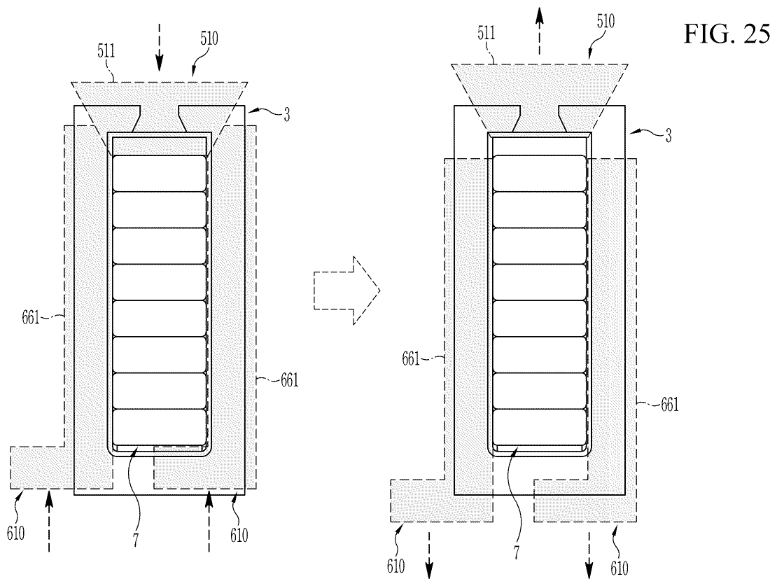

In addition, as illustrated in FIG. 25, the core inner clamper 410, the coil inner clamper 510, the upper coil clamp unit 540, and the lower coil clamp unit 610 may clamp the upper portions and the lower portions of the stator coils 7 at several positions (e.g., in the directions toward the inner side, the outer side, and the two opposite sides).

Therefore, the clamping device 100 for a stator manufacturing system according to the embodiment of the present disclosure may clamp the stator core 3 and the stator coils 7 at several positions by means of the core inner clamper 410, the coil inner clamper 510, the upper coil clamp unit 540, and the lower coil clamp unit 610.

Therefore, the clamping device 100 for a stator manufacturing system according to the embodiment of the present disclosure may transfer the stator core 3 to the processing processes (e.g., the coil widening process and the coil twisting process) for the stator coils 7 in the state in which the stator core 3 and the stator coils 7 are clamped.

According to the clamping device 100 for a stator manufacturing system according to the embodiment of the present disclosure described above, the processing processes may be performed on the stator coils 7 in the state in which the stator core 3 and the stator coils 7 are clamped.

Therefore, the clamping device 100 for a stator manufacturing system according to the embodiment of the present disclosure may minimize a positional dispersion between the stator coils 7, which is caused when the stator core 3 is transferred between the processes and ensure processing quality of the stator coils 7.

In addition, the clamping device 100 for a stator manufacturing system according to the embodiment of the present disclosure may reduce facility investment costs and production costs because a dedicated clamp device does not need to be used for each of the processing processes.

Further, the clamping device 100 for a stator manufacturing system according to the embodiment of the present disclosure may clamp the stator core 3 and the stator coils 7 at several positions by means of the core inner clamper 410, the coil inner clamper 510, the upper coil clamp unit 540, and the lower coil clamp unit 610.

Therefore, the clamping device 100 for a stator manufacturing system according to the embodiment of the present disclosure may prevent inadvertent movements of the stator coils 7, thereby minimizing processing quality dispersions of the stator coils 7.

While the present disclosure has been described in connection with what is presently considered to be practical example embodiments, it is to be understood that the present disclosure is not limited to the disclosed embodiments, but, on the contrary, is intended to cover various modifications and equivalent arrangements included within the spirit and scope of the appended claims.

<Description of symbols>

| | |
|---|---|
| 1: Stator manufacturing system | 3: Stator core |
| 4: Protruding portion | 4a: Inner diameter surface |
| 4b: Outer diameter surface | 5: Slot |
| 6: Insulation sheet | 7: Stator coil |
| 10: Coil inserting process | 30: Coil widening process |
| 50: Coil twisting process | 70: Coil welding process |
| 100: Clamping device for | |
| stator manufacturing system | |
| 110: Main body | 115: Core height measurement part |
| 201: Base frame | 205: Clamper transfer unit |
| 210: Shuttle plate | 211: Shuttle conveyance route |
| 221: Shuttle driving part | 250: Lifting plate |
| 251: Guide rod | 253: Upper mounting hole |
| 261: Main actuator | 263: Main servo motor |
| 265: Main movement block | 267: Main lead screw |
| 269: Main support block | 310: Sub-body |
| 311: Body guide rail | 331: Body driving part |
| 333, 434, 683: Operation cylinder | 410: Core inner clamper |
| 411: Guide housing | 421: Guide tube |
| 423: Guide hole | 431: Collet member |
| 433: Collet driving part | 435: Cone portion |
| 437: Rail groove | 441: Clamp jaw |
| 443: Core clamping surface | 445: Rail protrusion portion |
| 451: Coil inner clamper | 461: Coil cap member |
| 463: Cap body | 465: Coil guide ring |
| 467: Coil crown guide portion | 469: Coil support groove |
| 471: Core upper clamping pad | 510: Coil inner clamper |
| 511: Clamping block | 513: First portion |
| 515: Second portion | 540: Upper coil clamp unit |
| 541: Upper support ring | 551: Upper cam disc |
| 553: Upper guide rail groove | 561: Upper swing plate |
| 563: Upper part gear | 565: Upper cam follower groove |
| 571: Upper clamp actuator | 573: Upper servo motor |
| 575: Upper pinion gear | 581: Upper clamp needle |
| 583: First clamping portion | 585: Second clamping portion |
| 591: Upper cam lobe | 610: Lower coil clamp unit |
| 611: Lower support ring | 613: Rib |
| 615: Guide bar | 621: Core support disc |
| 623: Core support ring | 625: Core guide block |
| 631: Lower cam disc | 633: Lower guide rail groove |
| 641: Lower swing plate | 643: Lower part gear |
| 645: Lower cam follower groove | 651: Lower clamp actuator |
| 653: Lower servo motor | 655: Lower pinion gear |
| 661: Lower clamp needle | 663: Third clamping portion |
| 665: Fourth clamping portion | 671: Lower cam lobe |
| 681: Sub-actuator | |

What is claimed is:

1. A clamping device for a stator manufacturing system, which manufactures a stator having a stator core around which hairpin-type stator coils are wound, the clamping device comprising:
a main body connected to a clamper transfer unit;
a sub-body installed on the main body and configured to be movable in an upward/downward direction;
a core inner clamper installed on the sub-body and configured to clamp an inner diameter surface of the stator core; and
a coil inner clamper installed on the core inner clamper and configured to clamp inner sides of lower portions of the stator coils.

2. The clamping device of claim 1, wherein the core inner clamper comprises:
a guide housing fixed to the sub-body;
a guide tube disposed inside the guide housing, the guide tube extending through the guide housing in the upward/downward direction and fixed to the sub-body;
a collet member disposed inside the guide tube, installed on the sub-body, and configured to be movable in the upward/downward direction; and
a plurality of clamp jaws coupled to a cone portion formed on a lower portion of the collet member, configured to be slidable in the upward/downward direction, and mounted to be movable via a plurality of guide holes formed in a lower portion of the guide tube.

3. The clamping device of claim 2, wherein:
the coil inner clamper comprises a plurality of clamping blocks fixed to respective lower portions of the clamp jaws, each clamping block contacting the inner sides of the lower portions of the stator coils protruding from a lower end of the stator core.

4. The clamping device of claim 3, wherein the clamp jaws each comprise:
a core clamping surface configured to clamp an inner diameter surface of the stator core; and
a rail protrusion portion slidably coupled to a rail groove formed in the cone portion of the collet member in the upward/downward direction.

5. The clamping device of claim 4, wherein the clamping blocks each comprise:
a first portion fixed to the lower portion of each of the clamp jaws; and
a second portion extending from the first portion toward the core clamping surface of each of the clamp jaws.

6. The clamping device of claim 1, wherein:
the core inner clamper further comprises a coil cap member fixed to the guide housing and configured to support an upper portion of the stator coil.

7. The clamping device of claim 6, wherein the coil cap member comprises:
a ring-shaped cap body fixed to the guide housing; and
a coil guide ring fixed to a lower portion of the cap body and having a coil crown guide portion having a diameter that decreases upward from a lower end thereof to guide the upper portion of each of the stator coils.

8. The clamping device of claim 7, wherein:
a plurality of coil support grooves are formed in an inner peripheral surface of the cap body and configured to support the upper portions of the stator coils.

9. The clamping device of claim 6, wherein:
the core inner clamper further comprises a plurality of core upper clamping pads mounted on a lower portion of the coil cap member and configured to clamp an upper portion of the stator core.

10. The clamping device of claim 1, further comprising:
a shuttle plate coupled to the clamp transfer unit and provided to be movable along a shuttle conveyance route preset on a base frame;
a lifting plate installed on the shuttle plate and configured to be movable in the upward/downward direction;
an upper coil clamp unit installed on the lifting plate and configured to clamp upper portions of the stator coils; and
a lower coil clamp unit disposed below the upper coil clamp unit, connected to the lifting plate, and configured to clamp the lower portions of the stator coils.

11. The clamping device of claim 10, wherein the upper coil clamp unit comprises:
an upper support ring disposed below the lifting plate having an upper mounting hole, the upper support ring being fixed to an edge portion of the upper mounting hole;
an upper cam disc coupled to a lower portion of the upper support ring and having a plurality of upper guide rail grooves formed in an upper surface thereof;
an upper swing plate mounted to be rotatable between the upper support ring and the upper cam disc and connected to an upper clamp actuator installed on the lifting plate, the upper swing plate having a plurality of upper cam follower grooves formed in a cyclone shape in a lower surface thereof;
a plurality of upper clamp needles slidably coupled to the upper guide rail grooves of the upper cam disc; and
a plurality of upper cam lobes fixed to the upper clamp needles and slidably coupled to the upper cam follower grooves of the upper swing plate.

12. The clamping device of claim 11, wherein the upper clamp needles each comprise:
a first clamping portion configured to clamp an outer side of the upper portion of each of the stator coils in an inward direction of the stator core; and
a second clamping portion configured to clamp a lateral surface of the upper portion of each of the stator coils in a layer direction of the stator coils.

13. The clamping device of claim 11, wherein:
a plurality of pad docking holes are formed in the upper clamp needles and coupled to a plurality of core upper clamping pads provided on the core inner clamper.

14. The clamping device of claim 10, wherein the lower coil clamp unit comprises:
a lower support ring disposed in a lower mounting hole formed in the shuttle plate, mounted on the lifting plate, and configured to be movable in the upward/downward direction;
a core support disc coupled to a lower portion of the lower support ring;
a lower cam disc coupled to a lower portion of the core support disc and having a plurality of lower guide rail grooves radially formed in an upper surface thereof;
a lower swing plate rotatably mounted between the core support disc and the lower cam disc and connected to a lower clamp actuator installed on the lower support ring, the lower swing plate having a plurality of lower cam follower grooves formed in a cyclone shape in a lower surface thereof;
a plurality of lower clamp needles slidably coupled to the lower guide rail grooves of the lower cam disc; and
a plurality of lower cam lobes fixed to the lower clamp needles and slidably coupled to the lower cam follower grooves of the lower swing plate.

15. The clamping device of claim 14, wherein the lower coil clamp unit further comprises:
a core support ring coupled to an inner edge portion of the core support disc; and
at least one core guide block fixed to the lower support ring.

16. The clamping device of claim 14, wherein the lower clamp needles each comprise:
a third clamping portion configured to clamp an outer side of the lower portion of each of the stator coils in an inward direction of the stator core; and
a fourth clamping portion configured to clamp a lateral surface of the lower portion of each of the stator coils in a layer direction of the stator coils.

17. A clamping device for a stator manufacturing system, the clamping device comprising:
a main body connected to a clamper transfer unit;
a sub-body installed on the main body and configured to be movable in an upward/downward direction;
a core inner clamper installed on the core inner clamper and configured to clamp inner sides of lower portions of stator coils;
a shuttle plate provided to be movable along a shuttle conveyance route preset on a base frame;
a lifting plate installed on the shuttle plate and configured to be movable in the upward/downward direction;
an upper coil clamp unit installed on the lifting plate and configured to clamp upper portions of the stator coils;
a lower coil clamp unit disposed below the upper coil clamp unit and configured to clamp lower portions of the stator coils; and
at least one sub-actuator installed on the lifting plate and operatively connected to the lower coil clamp unit,
wherein the sub-actuator is configured to move the lower coil clamp unit in an upward/downward direction independently of an upward/downward movement of the lifting plate.

18. The clamping device of claim 17, wherein the sub-actuator comprises an operation cylinder installed on the lifting plate and connected to the lower coil clamp unit by at least one guide bar that penetrates the lifting plate in the upward/downward direction.

19. The clamping device of claim 17, wherein the lower coil clamp unit comprises:
a lower cam disc having a plurality of lower guide rail grooves radially formed in an upper surface thereof; and
a plurality of lower clamp needles radially slidably coupled to the lower guide rail grooves of the lower cm disc, each of the lower camp needs comprising:

20. The clamping device of claim 17, wherein the lower coil clamp unit further comprises:
a lower support ring disposed on the lifting plate and configured to be movable in the upward/downward direction;
a core support disc coupled to a lower portion of the stator core.
